(19) United States
(12) Patent Application Publication
(10) Pub. No.: US 2010/0170244 A1
(43) Pub. Date: Jul. 8, 2010

(54) ROBUST MULTIPLE INPUT MULTIPLE OUTPUT CONTROL IN A HIGH VARIABILITY SYSTEM

(76) Inventors: Martin T. Brooks, Columbus, IN (US); Yue Yun Wang, Troy, MI (US); Feng Zhang, Columbus, IN (US)

Correspondence Address: KRIEG DEVAULT LLP, ONE INDIANA SQUARE, SUITE 2800, INDIANAPOLIS, IN, 46204-2079, US

(21) Appl. No.: 12/553,510

(22) Filed: Sep. 3, 2009

Related U.S. Application Data
(60) Provisional application No. 61/191,014, filed on Sep. 3, 2008.

(51) Int. Cl. F02B 37/12; F02D 21/04; F02B 47/08

(52) U.S. Cl. 60/602; 123/568.21; 60/605.2

(57) ABSTRACT

One embodiment is a method including interpreting a static decoupling gain set for a gas flow handling system having a plurality of inputs and a plurality of outputs. The static decoupling gain set includes gain value sets, where each gain value set decouples the plurality of inputs from the plurality of outputs at a frequency of interest and specified system operating condition of the gas flow handling system. The method further includes calculating an error term based on at least one of the inputs and a current value corresponding to one of the outputs. The method further includes providing an adjusted controller gain in response to a current system operating condition and the static decoupling gain set, and determining actuator responses based on the adjusted controller gain and the at least one error term.

### RELATED APPLICATIONS

This application is related, and claims the benefit of, U.S. Provisional Patent Application 61/191,014 entitled Robust Multiple Input Multiple Output Control in a High Variability System filed Sep. 3, 2008, which is incorporated herein by reference.

### BACKGROUND

The technical field generally relates to multiple input multiple output (MIMO) control of systems with high variability across an operating range, and more particularly relates to control of an air handling system for an internal combustion engine.

Modern engines often utilize exhaust gas recirculation (EGR) to meet new emissions regulation targets. Air handling systems must be equipped to meet charge air composition targets (e.g. an EGR fraction target) to achieve emissions targets, and meet total air available targets (e.g. the charge flow mass flow) to achieve desired power and torque targets. The actuators that most strongly affect EGR flow generally affect charge flow, and the actuators that most strongly affect charge flow generally affect EGR flow. Therefore, an engine with a modern air handling system presents a multiple input multiple output (MIMO) system with coupled input-output response loops.

MIMO systems, where the inputs are coupled—i.e. the input-output response loops affect each other—present well known challenges in the art. An engine air handling system presents further challenges. The engine operates over a wide range of parameters including variable engine speeds, variable torque outputs, and variable fueling and timing schedules. In many cases, exact transfer functions for the system are unavailable and/or the computing power needed for a standard decoupling calculation is not available. Accordingly, there is a demand for further contributions in this area of technology.

### SUMMARY

One embodiment is a unique MIMO control technique. Other embodiments include unique methods, systems, and apparatus to control an internal combustion engine. Further embodiments, forms, objects, features, advantages, aspects, and benefits shall become apparent from the following description and drawings.

### BRIEF DESCRIPTION OF THE FIGURES

FIG. 1 is a schematic block diagram of a system for multiple-input multiple-output control.

FIG. 2 is schematic block diagram of a controller.

FIG. 3 is schematic block diagram of an alternate embodiment of a controller.

FIG. 4 is an illustration of a dynamic response set for each of a plurality of outputs.

FIG. 5 is an illustration of an adjusted dynamic response based on the dynamic response set for each of a plurality of outputs and a static decoupling gain set.

FIG. 6 is a schematic illustration of a static decoupling gain set.

FIG. 7 is a schematic illustration of an alternate embodiment of a static decoupling gain set.

FIG. 8 is a schematic illustration of a multiple-input multiple-output control loop.

### DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated embodiments, and that such further applications of the principles of the invention as illustrated therein as would normally occur to one skilled in the art to which the invention relates are contemplated and protected.

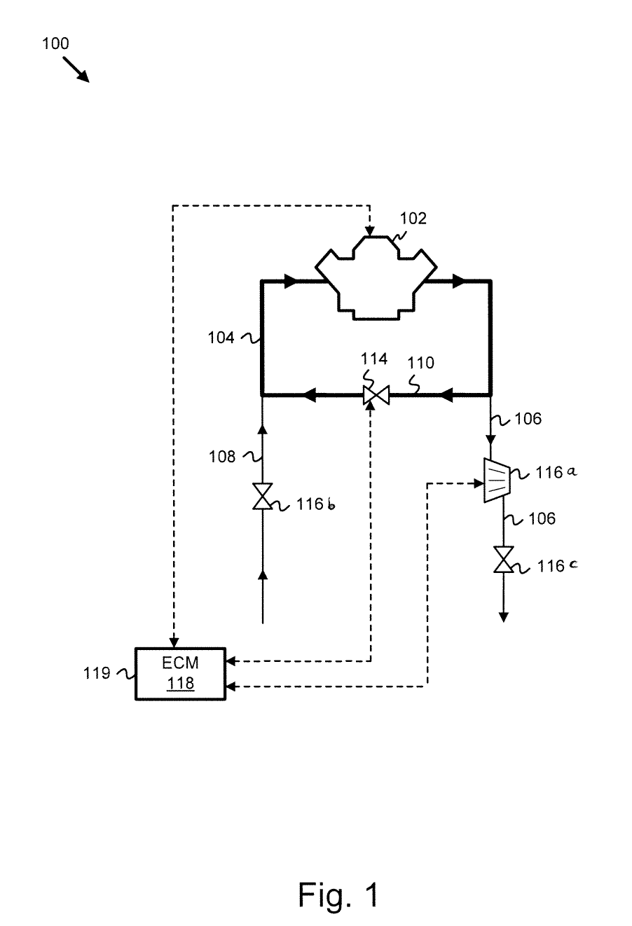

FIG. 1 is a schematic block diagram of a system 100 for multiple-input multiple-output control. The system 100 includes a gas flow handling system. In the embodiment of FIG. 1, the gas flow handling system includes an internal combustion engine 102 having a charge flow 104 and an exhaust flow 106. The charge flow 104 includes an air inlet stream 108 and exhaust flow 106 through an exhaust gas recirculation (EGR) path 110. The charge flow 104 includes gases utilized in the engine 102, whether mixed, provided via more than one intake manifold, or retained within a combustion chamber in the engine.

The system 100 further includes a turbocharger 116a that receives at least a portion of the exhaust flow 106. In one embodiment, the EGR path 110 supplies a portion of the exhaust flow 106 to the charge flow 104. The EGR path 110 includes an EGR valve 114 adapted control a flow area (not shown) of the EGR path 110. The system further includes a turbocharger swallowing capacity modifier 116. The turbocharger swallowing capacity modifier 116 is illustrated as a variable geometry turbocharger (VGT) 116a, an intake throttle valve 116b, and/or an exhaust throttle valve 116c. Any other device for modifying the turbocharger swallowing capacity (e.g. waste gate, bypass valve, etc.) is understood within the scope of the present application.

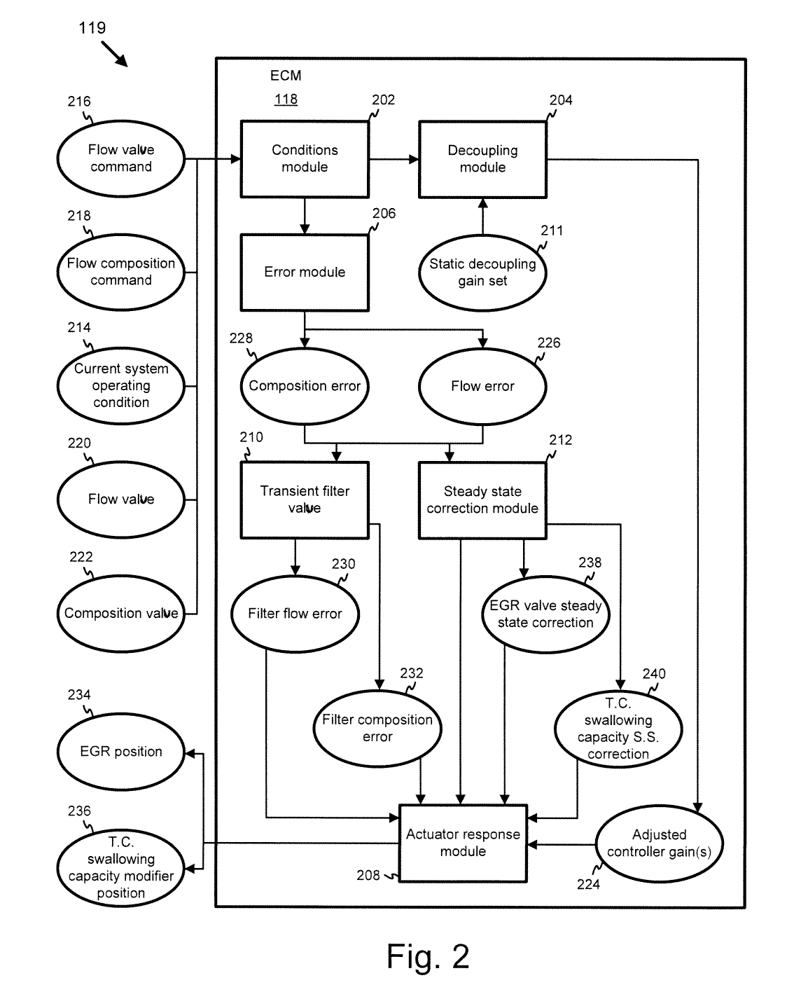

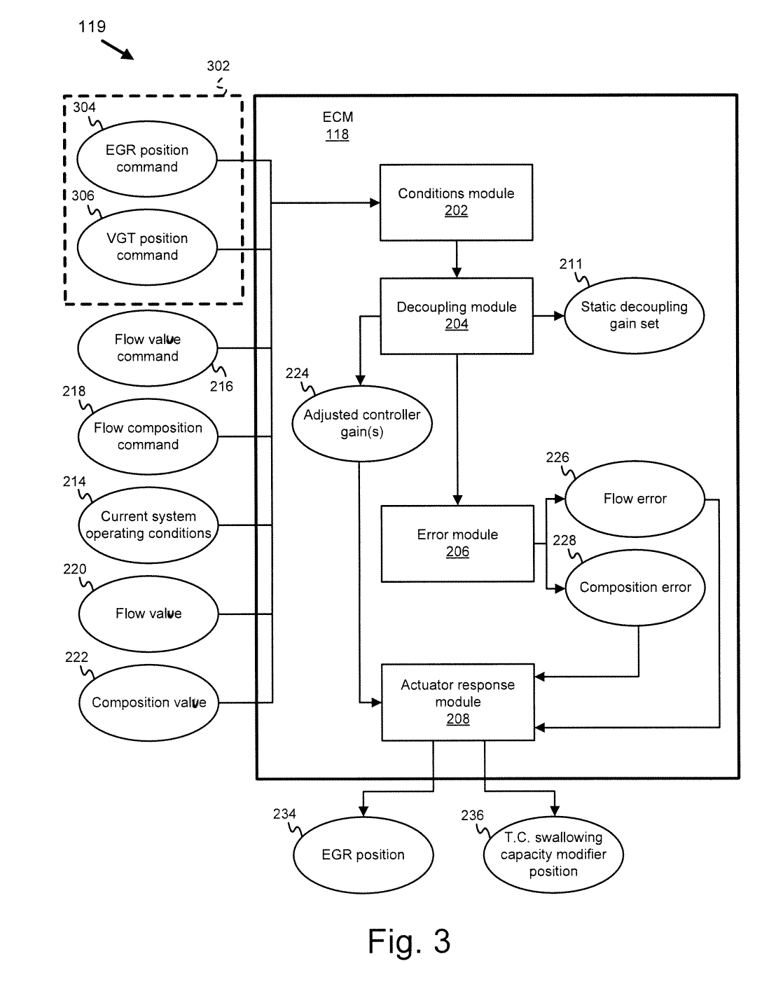

The system 100 further includes a controller 118, which may be included on a processing subsystem 119. The processing subsystem 119 may include various controllers, electronic components, communication devices, processors and/or memory devices that functionally execute certain operations of the system 100. The operations of the controller 118 and/or the processing subsystem 119 may be functionally executed by various modules, or by other components as understood in the art. In certain embodiments, the controller 118 may include a conditions module, a decoupling module, an error module, and/or an actuator response module. The modules may comprise computer executable code on a computer-readable medium, and may be stored on the controller 118 and/or distributed throughout the system 100. Further descriptions of some embodiments of the controller 118 and modules are provided in the descriptions referencing FIGS. 2 and 3.

The controller 118 operates various portions of an air-handling system for the engine 102. For example, the controller 118 may determine a target charge flow 104 amount and composition, and control the EGR valve 114 and one or more turbocharger swallowing capacity modifiers 116 to achieve the target charge flow 104 amount and composition. In another exemplary embodiment, the controller 118 determines a target charge flow 104 and a target EGR flow 110, and controls the EGR valve 114 and one or more turbocharger swallowing capacity modifiers 116 to achieve the target charge flow 104 and a target EGR flow 110. The controller 118 may control any set of multiple outputs based on any set of multiple inputs within the system 100, including other air-handling inputs and outputs understood in the art.

FIG. 2 is schematic block diagram of a controller 118 included as a portion of a processing subsystem 119. The controller 118 illustrated in FIG. 2 includes a conditions module 202, a decoupling module 204, an error module 206, and an actuator response module 208. In certain embodiments, the controller 118 further includes a transient filter module 210 and a steady state correction module 212. Other controller 118 arrangements that functionally execute the operations of the controller 118 are contemplated in the present application.

The conditions module 202 interprets a current system operating condition 214, an intake flow value command 216, and an intake flow composition command 218. The system operating condition 214 may be any operating condition, where a change in the operating condition causes a change in the system output response to a system input. For example, a change in current engine 102 horsepower output may cause the EGR fraction response to an EGR fraction command to change (i.e. the EGR fraction responds more quickly or less quickly to an EGR fraction command change), where in the example the current engine horsepower output is the system operating condition 214, the EGR fraction is the system output, and the EGR fraction command is the system input.

Other potential system operating conditions, without limitation, may be an engine speed, an engine torque output, a current engine operating mode (e.g. “starting”, “regenerating”, etc.), a description of the amount of transience currently experienced by the engine (e.g. “steady state”, “transient”, “highly transient”), or a description of a current emissions target for the engine. The system operating condition 214 may be quantified as a numeric value, and may be a value selected from a discrete set of values, or a continuous (or partially continuous) calculated value or interpolated value between discrete values. Further, the system operating condition 214 may comprise more than one operating condition, for example the engine speed and the engine torque output.

In one embodiment, the intake flow value command 216 is a command describing a target charge flow 104 mass. The intake flow value command 216 may be any other charge flow 104 amount description understood in the art. The intake flow value command 216 may be provided by a separate controller or by another module within the controller 118 (not shown). The intake flow value command 216 may be communicated over a datalink, communicated within the controller 118, received wirelessly, or through any other communication means in the art.

In one embodiment, the intake flow composition command 218 is a command describing an EGR fraction value, which may be the target fraction of the total charge flow 104 that is contributed by the EGR flow 110. The intake flow composition command 218 may be, without limitation, an oxygen fraction target, an inert gas fraction target, or any other composition description of the charge flow 104 understood in the art. The intake flow composition command 218 may be provided by a separate controller or by another module within the controller 118 (not shown). The intake flow composition command 218 may be communicated over a datalink, communicated within the controller 118, received wirelessly, or through any other communication means in the art.

In certain further embodiments, the conditions module 202 interprets at least one current value corresponding to at least one system output. For example, a system output may be a charge flow value, a charge composition value, and/or and EGR fraction. The current values may include a current charge flow value 220, a current charge composition value 222, and/or a current EGR fraction (not shown). Interpreting a current value includes, without limitation, reading the value from a memory location, receiving the value over a datalink, receiving the value as a physical value (e.g. a voltage reading from a sensor), and/or calculating the value from one or more other parameters.

The decoupling module 204 provides an adjusted controller gain 224 (or gains) in response to the current system operating condition 214 and a static decoupling gain set 211. The static decoupling gain set 211 is a set of gains or a set of gain matrices, each gain (or matrix) associated with a system operating condition 214. In certain embodiments, the static decoupling gain set 211 includes a plurality of gain value sets, each gain value set corresponding to a system operating condition 214. For example, the static decoupling gain set 211 may be a set of gains each associated with an engine horsepower output, and the decoupling module 204 selects one of the set of gains 211 based on the current engine horsepower output (i.e., the current system operating condition 214). The decoupling module 204 may select an exactly matching set of gains, an interpolated set of gains, or a closest-match set of gains. For example, if the current system operating condition 214 is 350 horsepower (hp) output, and the static decoupling gain set 211 includes a gain set entry for 300 hp and a gain set entry for 400 hp, the decoupling module 204 may interpolate between the gain set at 300 hp and the gain set at 400 hp to provide the adjusted controller gain 224. Interpolation may be performed by any interpolation method understood in the art, including but not limited to linear interpolation.

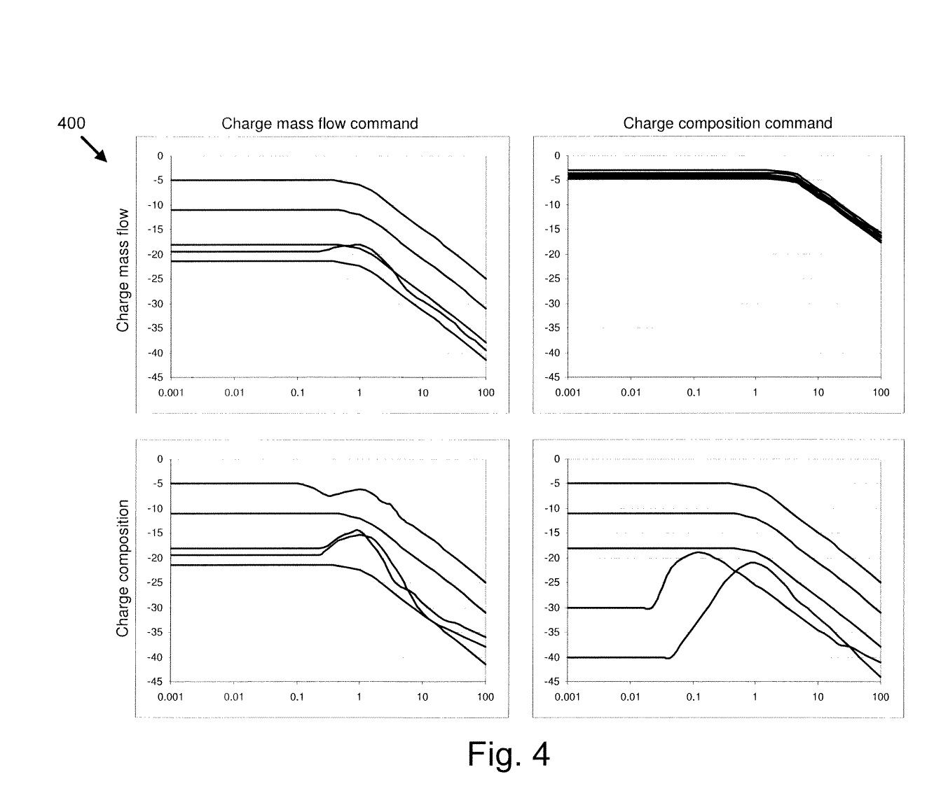

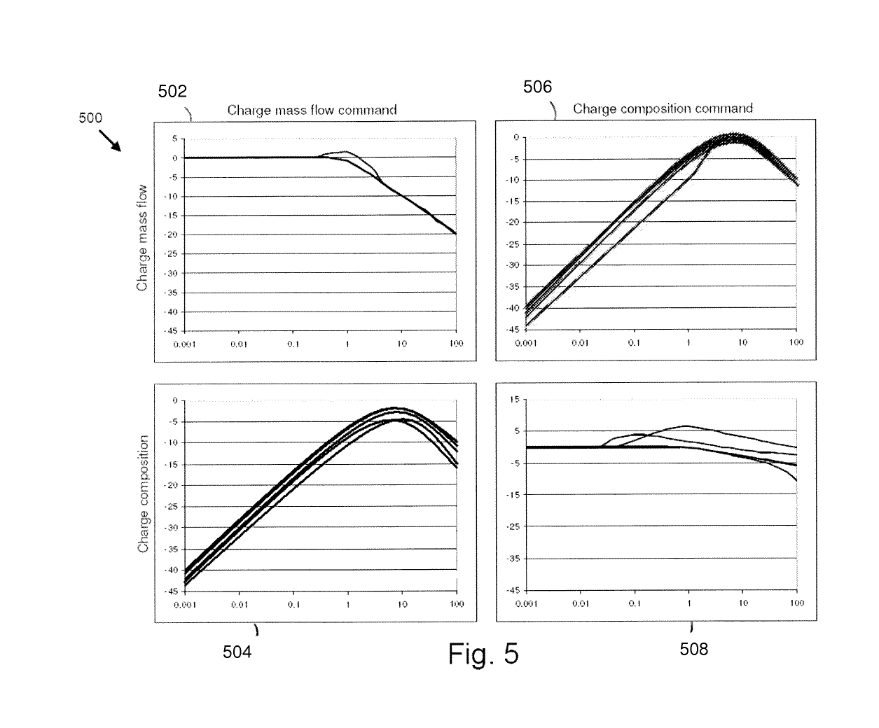

The static decoupling gain set 211 is determined by performing a system identification at a frequency of interest. In one embodiment, the static decoupling gain set 211 is determined by determining a dynamic response set for each output corresponding to each input. Each dynamic response set comprises a plurality of dynamic responses, each dynamic response corresponding to a system operating condition 214. Further detail on the system identification 214 is included in the description referencing FIGS. 4 and 5.

In a further embodiment, the adjusted controller gain(s) 224 may be a basic gain set (not shown) for the system 100 adjusted by the gains selected from the static decoupling gain set 211. For example, the current controller gain for the EGR valve (a potential output for the controller 118) may have a basic value under the conventional controls scheme, and the decoupling module 204 provides the adjusted controller gain 224 by modifying the basic value of the EGR valve controller gain with the selected gain(s) from the static decoupling gain set.

The error module 206 calculates one or more error terms 226, 228 based on the input(s) 216, 218 and the current value(s) 220, 222. For example, the flow value command 216 may have a value of 40 lbm/min charge flow rate target, and the flow value 220 may have a value of 25 lbm/min current charge flow rate. In the example, the flow error term 226 comprises an error based on 15 lbm/min charge flow difference. The actual units and value of the error terms 226, 228 may not be identical to the difference between the inputs 216, 218 and the current values 220, 222 due to filtering, weighting, and/or other processing by the error module 206. In one embodiment, the error module calculates a charge flow error term 226 based on the charge flow command 216 and the current charge flow 220. In certain embodiments, the error module calculates a charge composition error term 228 based on the charge composition command 218 and the current charge composition 222.

In certain embodiments, the controller 118 includes a transient filter module 210 that filters the error terms 226, 228. In one example, the transient filter module 210 is present when the control scheme to achieve the flow value command 216 and the flow composition command 218 is an H-infinity control scheme, however the transient filter module 210 may be present in other contexts. In one embodiment, the transient filter module 210 filters the error terms 226, 228 with a lead-lag filter, although the transient filter may apply any type of dynamic compensation known in the art.

Those of skill in the art will recognize that a lead-lag filter can be configured to apply a fixed, relatively high gain to a signal at a relatively low frequency, and a fixed, relatively low gain to the signal at a relatively high frequency, with a transitional gain function between the low frequency and the high frequency. Therefore, in one embodiment, the transient filter module 210 applies a high gain multiplier when the error terms 226, 228 are changing slowly, and applies a low gain multiplier when the error terms 226, 228 are changing quickly. In one embodiment, the transient filter module 210 provides a lead-lag filter such that the error terms 226, 228 are not adjusted (i.e. 0 dB adjustment) at about 1 Hz, with a 40 dB adjustment at about 0.005 Hz (or, the low “corner frequency”) and a −40 dB adjustment at about 500 Hz (or, the high “corner frequency”). In certain embodiments, the transient filter module 210 filters each error term 226, 228 with a separate filter. For example, in one embodiment the transient filter module 210 filters the charge flow error term 226 with a first lead-lag filter, and filters the charge composition error term 228 with a second lead-lag filter.

The selection of the filtering, including frequencies of interest and gains applied, of the error terms 226, 228 depends upon the system 100 responses, magnitudes of the errors experienced, and the expected frequency of errors and disturbances. The transient filter module 210 may further apply separate filters to each error term 226, 228. The transient filter module 210 supplies the filtered error terms—for example the filtered charge flow error term 230 and the filtered charge composition error term 232—to the actuator response module 208.

The controller 118 includes an actuator response module 208 that determines a plurality of actuator responses 234, 236 based on the adjusted controller gain(s) 224 and the error term(s) 226, 228, which may be accepted as filtered error terms 230, 232. In one embodiment, the actuator responses include an EGR valve position 234 and a turbocharger swallowing capacity modifier position 236. The actuator response module 208 may apply any control scheme known in the art to generate actuator responses 234, 236 based on the error term(s) 226, 228 or 230, 232, including, without limitation, a proportional-integral (PI), proportional-integral-derivative (PID), H-infinity, fuzzy logic, or neural network controller. The turbocharger swallowing capacity modifier may be a VGT, exhaust valve, waste gate, or intake valve, and the turbocharger swallowing capacity modifier position 236 may be a position of the turbocharger swallowing capacity modifier.

In certain embodiments, the actuator response module 208 applies the adjusted controller gain(s) 224 to an intermediate actuator response (not shown) that would otherwise be provided for the actuator response(s) 234, 236. In an alternate embodiment, the actuator response module 208 applies the adjusted controller gain(s) 224 to the error terms 226, 228 or filtered error terms 230, 232 before processing with the control scheme. In certain embodiments, the adjusted controller gain(s) 224 may be applied differently to differing aspects of the control scheme—for example separate gain adjustments 224 may be applied to a proportional control term and to an integral control term. The adjusted controller gain(s) 224 may be multiplier values or decoupling matrices. Refer to the description referencing FIGS. 4 through 7 for more specific details on the adjusted controller gain(s) 224 and the static decoupling gain set 211.

In certain embodiments, the controller 118 includes a steady state correction module 212. The steady state correction module 212 operates an integral control scheme on the charge flow error term 226 and/or the charge composition error term 228 to determine an EGR valve steady state correction response 238 and a turbocharger swallowing capacity modifier steady state correction response 240. The actuator response module 208 utilizes the steady state correction responses 238, 240 to eliminate steady state offset error for the charge flow 104 and charge composition. In some operating conditions, the filtering of the transient filter module 210 combined with the adjusted controller gains 224 can increase a tendency toward steady state offset, which can be eliminated by the steady state correction module 212. The steady state correction module 212 may utilize low gains such that control is dominated by the primary control scheme in the actuator response module 208, and the steady state corrections 238, 240 are utilized only to trim the final response toward zero error.

FIG. 3 is schematic block diagram of an alternate embodiment of a controller 118 included as a portion of a processing subsystem 119. The embodiment illustrated in FIG. 3 differs from the embodiment illustrated in FIG. 2 primarily in the use of control parameters 302. In the embodiment of FIG. 3, the static decoupling gain set 211 is determined by performing a system identification at a frequency of interest. In one embodiment, the static decoupling gain set 211 is determined by determining a dynamic response set for each output corresponding to each control parameter 302. Each dynamic response set comprises a plurality of dynamic responses, each dynamic response corresponding to a system operating condition 214. Further detail on the system identification 214 is included in the description referencing FIGS. 4 and 5. In one embodiment, as illustrated in FIG. 3, the control parameters 302 are actuator responses including an EGR position command 304 and a VGT position command 306. In certain embodiments (not shown), the inputs 216, 218 are the control parameters 302.

The conditions module 202 interprets the inputs 216, 218 and the current system operating condition 214. The decoupling module 204 provides at least one adjusted controller gain 224 in response to the current system operating condition 214 and the static decoupling gain set 211. The error module 206 determines at least one error term 226, 228 based on the inputs 216, 218 and at least one current value 220, 222 corresponding to each of the outputs. The actuator response module 208 determines a plurality of actuator responses 234, 236 based on the adjusted controller gains 224 and the error terms 226, 228.

FIG. 4 is an illustration of a dynamic response set for each of a plurality of outputs 220, 222 corresponding to each of the inputs 216, 218. In the illustration of FIG. 4, the outputs are a charge mass flow 220 and a charge composition 222, and the inputs are a charge mass flow command 216 and a charge composition command 218. Each dynamic response set 402, 404, 406, 408 comprises a plurality of dynamic responses (plotted in FIG. 4 on a Bode plot), each corresponding to a particular system operating condition 214 (e.g. 100 hp). For example, the dynamic response 410 illustrates the response of actual charge mass flow 220 to a charge mass flow command 216 change at various frequencies. The plots in FIG. 4 show output responses to command changes, for example 404 illustrates charge mass flow changes to charge composition command changes, 406 illustrates charge composition changes to charge mass flow command changes, and 408 illustrates charge composition changes to charge composition command changes. The graphs in FIG. 4 are example data for illustrative purposes, and do not necessarily represent a real system.

The illustrations in FIG. 4 show the response of an underlying control system. For example, the charge mass flow change based on a charge mass flow command change occurs due to an underlying controller that determines responses of hardware actuators, then implements the hardware actuator responses. In certain alternate embodiments, the dynamic response sets capture the responses of the outputs 220, 222 to changes in control parameters 302. For example, a dynamic response set (not shown) may capture the responses of the charge mass flow to an EGR valve change at various frequencies, and a second dynamic response set may capture the responses of the charge mass flow to a turbocharger swallowing capacity modifier change.

The dynamic response sets of FIG. 4 may be utilized to develop a static decoupling gain set 211 by decoupling the dynamic responses at a frequency of interest. Idealized response would have one input directly control one output, which would be indicated by the dynamic responses for that input-output relationship in a horizontal line together at a high decibel value (preferably zero dB—or a gain of 1) regardless of the system operating condition. The idealized response would further have the output be insensitive to the non-matching input, or high negative dB values regardless of the system operating condition and frequency.

To develop a static decoupling gain set 211 from the dynamic response sets of FIG. 4, a frequency of interest is selected, and a gain is selected for each system operating condition that creates an idealized response to the extent possible. For example, if the input charge mass flow command should be related to the charge mass flow and not related to the charge composition, a frequency is selected, and in one example the realized gains indicated in FIG. 4 for each system operating condition are recorded as a series of matrices, and the static decoupling gain sets are stored as de-coupling matrices. For example, if the realized gain matrix is

$$\frac{[ AB ]}{[ CD ]}$$

as indicated in FIG. 4, the decoupling gain matrix is

$$\frac{[ D - B ]}{[ - CA ]} .$$

The development of gain matrices from data similar to that in FIG. 4, as well as decoupling matrices, is a mechanical step for one of skill in the art based on the disclosures herein. The data to build graphs such as displayed in FIG. 4 is a matter of simple data gathering, including sweeping the change frequency for each input versus each output at a plurality of system operating conditions. The selected system operating conditions should cover the desired range of operation, or at least the range of operation where well-behaved control is desirable or required. The taking of data and building information such as that illustrated in FIG. 4 comprises performing a system identification.

FIG. 5 is an illustration 500 of an adjusted dynamic response based on the dynamic response set for each of a plurality of outputs and a static decoupling gain set. The dynamic responses in FIG. 5 are example resulting input-output responses after application of the static decoupling gain set 211 as developed from the data of FIG. 4. As illustrated in FIG. 5, the static decoupling gain set 211 will clean up the responses near the frequency of interest, with potentially degraded performance away from the frequency of interest depending upon the dynamics of the system. As shown in the illustration of FIG. 5, after the application of the static decoupling gain set, the charge mass flow command input has a strong effect on the charge mass flow (see graph 502) and a weak effect on the charge composition (see graph 504). As shown further in the illustration of FIG. 5, the charge composition command has a weak effect on the charge mass flow (see graph 506) and a strong effect on the charge composition (see graph 508).

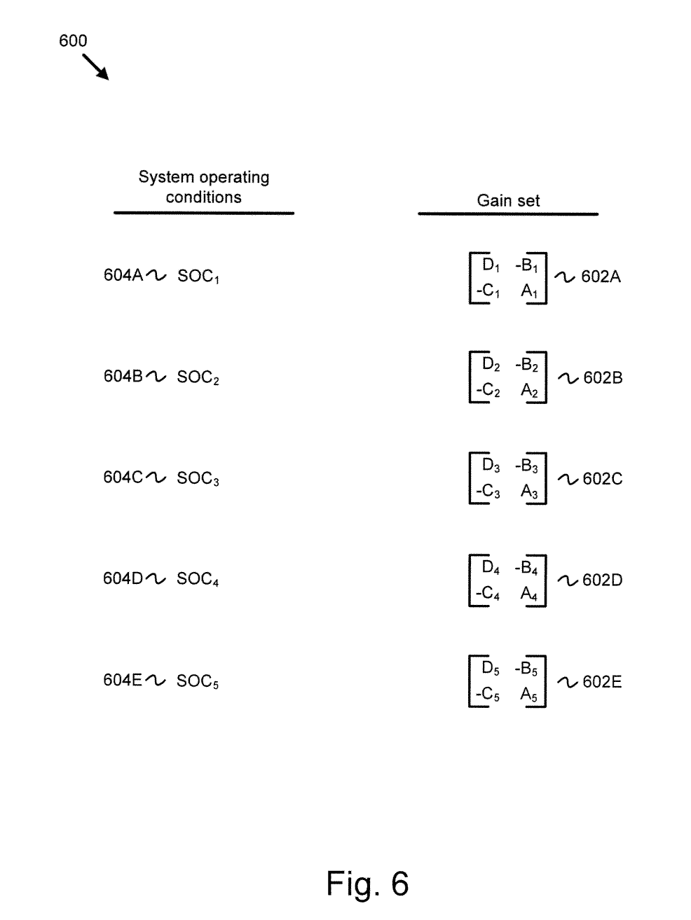

FIG. 6 is a schematic illustration 600 of a static gain set. As illustrated in FIG. 6, each static gain value 602A-602E corresponds to a specific operating condition 604A-604E. Further, each static gain value may be a gain value, a plurality of gain values, and/or a matrix of gain values. In one embodiment, each gain value 602 comprises a decoupling matrix of the gain values determined from data such as that shown in FIG. 4. The static decoupling gain set thereby comprises a set of decoupling matrices 602A-602E, each decoupling matrix corresponding to one of the system operating conditions 604A-604E. The selected gain values from the illustration of FIG. 6, after application to the nominal controller gains, comprise the adjusted controller gains 224.

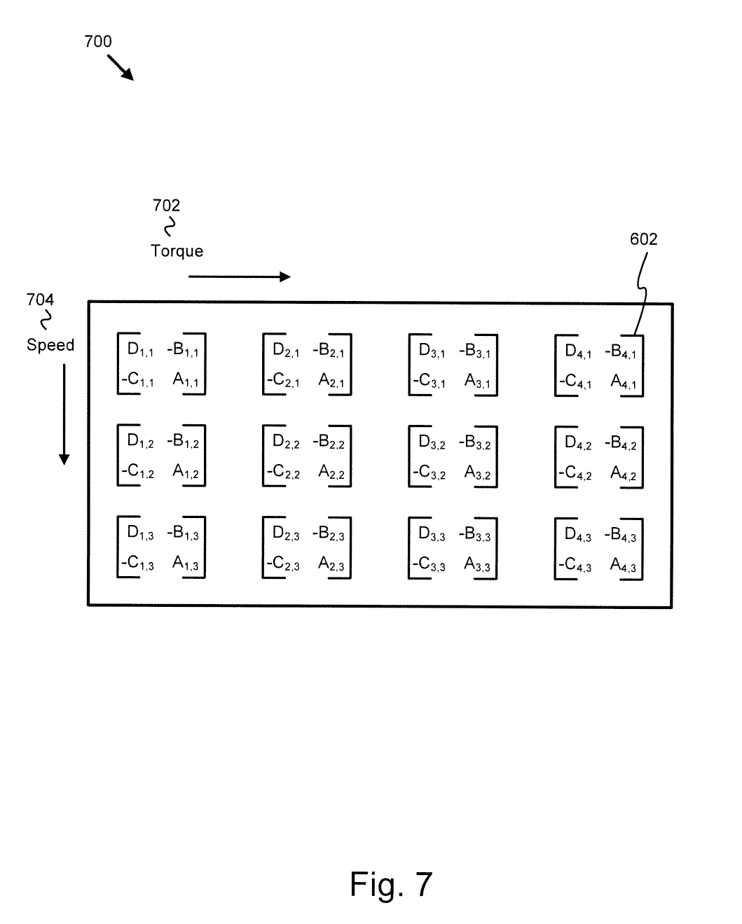

FIG. 7 is a schematic illustration 700 of an alternate embodiment of a static gain set. The illustration of FIG. 7 indicates that multiple system operating conditions 214 may be considered within the present application. For example, a system operating condition 702 may be engine torque output, and a system operating condition 704 may be an engine speed. Each gain set 602 comprises a gain set to be utilized based on the current system operating conditions 702, 704. The determination of the adjusted controller gains 224 from data such as illustrated in FIG. 7 includes interpolating within presented data, extrapolating outside presented data, and/or selecting a closest set of data to the current system operating conditions. Interpolation and/or extrapolation may occur on one axis, and nearest-selection on another axis.

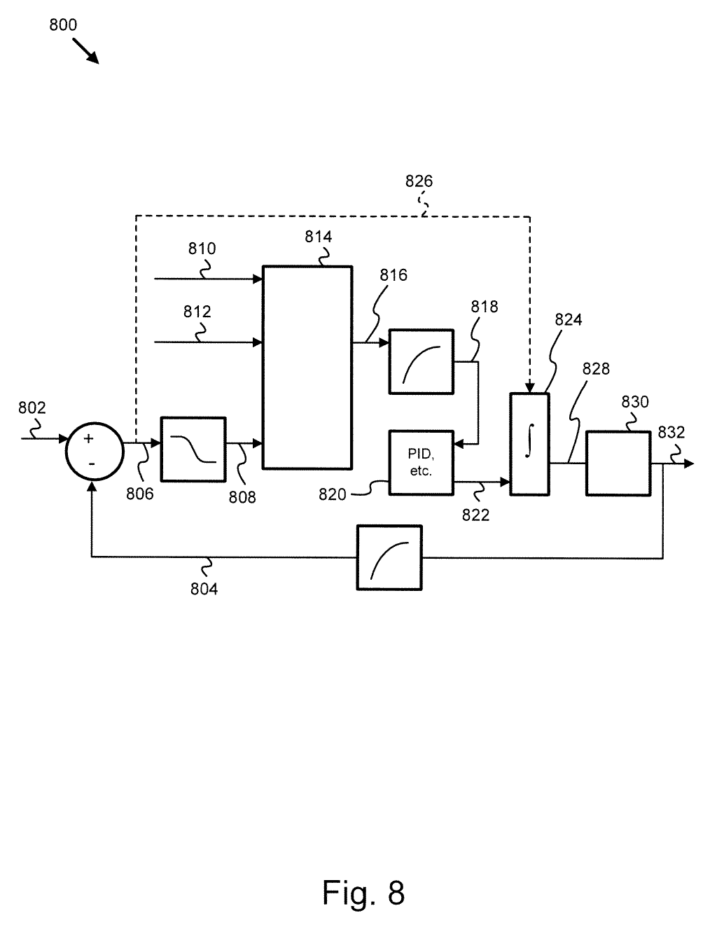

FIG. 8 is a schematic illustration 800 of a multiple-input multiple-output control loop. The illustration of FIG. 8 includes the control loop receiving the inputs 802, and comparing the inputs 802 to filtered outputs 804 to determine an unfiltered error term 806. The filtered outputs 804 may be generated by a high-pass filter as shown, or by any other type of dynamic compensation known in the art. A filtered error term 808 is combined with a system operating condition 810 and the static decoupling gain sets 812 for a decoupler 814 to determine adjusted controller gains 816. The filtered error term 808 may be generated by a lead-lag filter on the unfiltered error term 806 as shown, or by any other type of dynamic compensation known in the art.

The adjusted controller gains 816 may be filtered 818 and presented to a controller scheme 820 for processing. The filtered controller gains 818 may be generated by a high-pass filter as shown, or by any other type of dynamic compensation known in the art. The controller scheme 820 calculates a nominal controller response 822, and a steady state correction 824 may be applied utilizing the unfiltered 826 error values to determine an actuator response steady-state correction (or corrections) which combines with the nominal controller response(s) 822 for a final actuator response 828. The real system 830 acts on the final actuator response(s) 828 resulting in output(s) 832. The operations of FIG. 8 may be executed in the system 100, by a controller 118. Certain operations of FIG. 8 may be omitted, certain operations not shown in FIG. 8 may be added, and operations may be performed in a different order or performed in an alternate manner.

As is evident from the figures and text presented above, a variety of embodiments according to the present invention are contemplated.

In certain embodiments, a method includes providing a system including an internal combustion engine, the system having an intake flow value command and an intake flow composition command as inputs, and the system having an intake flow value and an intake flow composition value as outputs. The method further includes performing a system identification comprising: determining a dynamic response set for each of the outputs corresponding to each of the inputs, wherein each dynamic response set comprises a plurality of dynamic responses, each dynamic response corresponding to a system operating condition. The method further includes determining a static decoupling gain set based on the system identification at a frequency of interest. The method further includes calculating at least one error term based on at least one of the inputs and at least one current value corresponding to at least one of the outputs. The method further includes providing at least one adjusted controller gain in response to a current system operating condition and the static decoupling gain set. The method further includes determining a plurality of actuator responses based on the adjusted controller gain and the at least one error term, wherein the plurality of actuator responses comprises an exhaust gas recirculation (EGR) valve position and a turbocharger swallowing capacity modifier position.

In certain further embodiments, the method includes the turbocharger swallowing capacity modifier comprising a member selected from the group consisting of: a variable geometry turbocharger, an exhaust valve, a turbocharger waste gate, and an intake valve. In certain further embodiments, the method includes the intake flow value command comprising a charge flow command, and wherein the intake flow composition value command comprises a command selected from commands consisting of: an EGR fraction command, a fresh air flow command, and a charge O₂ fraction command, and the intake flow value comprises a charge mass flow and wherein the intake flow composition value comprises an EGR fraction. In certain further embodiments, the method includes filtering each at least one error term with a lead-lag filter. In certain further embodiments, the method includes filtering each at least one adjusted controller gain with a high pass filter. In certain further embodiments, the method includes filtering each at least one current value with a high pass filter to provide at least one filtered current value, and calculating the at least one error term based on the at least one filtered current value. In certain further embodiments, the method includes the static decoupling gain set comprising a set of decoupling matrices, each decoupling matrix corresponding to one of the system operating conditions. In certain further embodiments, the method includes determining the plurality of actuator responses further comprising operating a second integrator on the at least one error term.

In certain embodiments, a method includes providing a system including multiple inputs and multiple outputs and performing a system identification comprising: determining a dynamic response set for each of the multiple outputs corresponding to each of a plurality of control parameters, wherein each dynamic response set comprises a plurality of dynamic responses, each dynamic response corresponding to a system operating condition. The method further includes determining a static decoupling gain set based on the system identification at a frequency of interest and calculating at least one error term based on at least one of the multiple inputs and at least one current value corresponding to at least one of the multiple outputs. The method further includes providing at least one adjusted controller gain in response to a current system operating condition and the static decoupling gain set, and determining a plurality of actuator responses based on the adjusted controller gain and the at least one error term.

In certain further embodiments, the method includes the multiple inputs comprising an intake flow value command and an intake flow composition command. In certain further embodiments, the method includes the intake flow value command comprising a charge mass flow command, and wherein the intake flow composition command comprises a member selected from the group consisting of an exhaust gas flow recirculation (EGR) fraction command, a fresh air flow command, and a charge O₂ fraction command. In certain further embodiments, the method includes the multiple outputs comprising a charge mass flow and a charge composition value. In certain further embodiments, the method includes the charge composition value comprising a composition selected from the group consisting of an EGR fraction, a fresh air flow, and a charge O₂ fraction. In certain further embodiments, the method includes the plurality of control parameters comprising the multiple inputs. In certain further embodiments, the method includes the control parameters being actuator responses including an exhaust gas recirculation (EGR) valve position command and a variable geometry turbine (VGT) position command. In certain further embodiments, the method includes the multiple outputs comprising a charge mass flow and a charge composition value. In certain further embodiments, the method includes the charge composition value comprising a composition selected from the group consisting of an EGR fraction, a fresh air flow, and a charge O₂ fraction. In certain further embodiments, the method includes the plurality of actuator responses comprising an exhaust gas recirculation (EGR) valve position and a turbocharger swallowing capacity modifier position.

In certain embodiments, a method includes interpreting a static decoupling gain set for an internal combustion engine having a plurality of inputs and a plurality of outputs. The static decoupling gain set includes a plurality of gain value sets, wherein each gain value set decouples the plurality of inputs from the plurality of outputs at a frequency of interest and specified system operating condition of the internal combustion engine. In certain embodiments, the method further includes calculating at least one error term based on at least one of the inputs and at least one current value corresponding to at least one of the outputs, providing at least one adjusted controller gain in response to a current system operating condition and the static decoupling gain set; and determining a plurality of actuator responses based on the adjusted controller gain and the at least one error term. The plurality of actuator responses includes an exhaust gas recirculation (EGR) valve position and a turbocharger swallowing capacity modifier position. In certain further embodiments, the plurality of inputs includes an intake flow value command and an intake flow composition command, and the plurality of outputs includes an intake flow value and an intake flow composition value.

In certain embodiments, a system includes an internal combustion engine having a charge flow and an exhaust flow, a turbocharger adapted to receive at least a portion of the exhaust flow, and an exhaust gas recirculation (EGR) path adapted to supply a portion of the exhaust flow to the charge flow, the EGR path having an EGR valve adapted to control a flow area of the EGR path. The system further includes a turbocharger swallowing capacity modifier, and a controller comprising: a conditions module, a decoupling module, an error module, and an actuator response module. The conditions module interprets a current system operating condition, a charge flow command, and a charge composition command, a current charge flow, and a current charge composition. The decoupling module is configured to provide at least one adjusted controller gain in response to the current system operating condition and a static decoupling gain set. The error module is configured to calculate a charge flow error term based on the charge flow command and the current charge flow, and to calculate a charge composition error term based on the charge composition command and the current charge composition. The actuator response module is configured to determine an EGR valve position and a turbocharger swallowing capacity modifier position based on the at least one adjusted controller gain, the charge flow error term, and the charge composition error term.

In certain further embodiments, the system includes the charge composition command comprising an EGR fraction command. In certain further embodiments, the system includes the static decoupling gain set comprising a set of decoupling matrices, each decoupling matrix corresponding to a system operating condition. In certain further embodiments, the system including the actuator response module is further configured to provide an adjusted charge flow error term based on the charge flow error term and the at least one adjusted controller gain, to provide an adjusted charge composition error term based on the charge composition error term and the at least one adjusted controller gain, and to operate a control scheme on the adjusted charge flow error term and the adjusted charge composition error term. In certain further embodiments, the system includes the control scheme comprising one of an H-infinity controller and a proportional-integral controller. In certain further embodiments, the system includes the controller further comprising a transient filter module configured to filter the charge flow error term with a first lead-lag filter and to filter the charge composition error term with a second lead-lag filter, and a steady-state correction module configured to operate an integral control scheme on at least one of the unfiltered charge flow error term and the unfiltered charge composition error term to determine an EGR valve steady state correction response and a turbocharger swallowing capacity modifier steady state correction response. In certain further embodiments, the system includes the turbocharger swallowing capacity modifier comprising a member selected from the group consisting of: a variable geometry turbocharger, a turbocharger wastegate valve, an intake valve, and an exhaust valve.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred, more preferred or exemplary utilized in the description above indicate that the feature so described may be more desirable or characteristic, nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method, comprising:
interpreting a static decoupling gain set for an internal combustion engine having a plurality of inputs and a plurality of outputs, the static decoupling gain set comprising a plurality of gain value sets, wherein each gain value set decouples the plurality of inputs from the plurality of outputs at a frequency of interest and specified system operating condition of the internal combustion engine;
calculating at least one error term based on at least one of the inputs and at least one current value corresponding to at least one of the outputs;
providing at least one adjusted controller gain in response to a current system operating condition and the static decoupling gain set; and
determining a plurality of actuator responses based on the adjusted controller gain and the at least one error term, wherein the plurality of actuator responses comprises an exhaust gas recirculation (EGR) valve position and a turbocharger swallowing capacity modifier position.

2. The method of claim 1, wherein the plurality of inputs comprise an intake flow value command and an intake flow composition command, and wherein the plurality of outputs comprise an intake flow value and an intake flow composition value.

3. The method of claim 1, wherein the turbocharger swallowing capacity modifier position comprises a member selected from the group consisting of: a variable geometry turbocharger position, an exhaust valve position, a turbocharger waste gate position, and an intake valve position.

4. The method of claim 2, wherein the intake flow value command comprises a charge flow command, and wherein the intake flow composition command comprises a command selected from commands consisting of: an EGR fraction command, a fresh air flow command, and a charge O₂ fraction command.

5. The method of claim 4, wherein the intake flow value command comprises a charge mass flow and wherein the intake flow composition command comprises an EGR fraction.

6. The method of claim 1, further comprising dynamically compensating at least one of: each at least one error term, each at least one adjusted controller gain, and each at least one current value.

7. The method of claim 6, wherein the dynamically compensating comprises filtering each at least one error term with a lead-lag filter.

8. The method of claim 6, wherein the dynamically compensating comprises filtering each at least one adjusted controller gain with a high pass filter.

9. The method of claim 6, wherein the dynamically compensating comprises filtering each at least one current value with a high pass filter to provide at least one filtered current value, and calculating the at least one error term based on the at least one filtered current value.

10. The method of claim 1, wherein each gain value set comprises a decoupling matrix, each decoupling matrix corresponding to one of a set of system operating conditions.

11. The method of claim 1, wherein determining the plurality of actuator responses further comprises operating a second integrator on the at least one error term.

12. A method, comprising:
interpreting a static decoupling gain set for a gas flow handling system having a plurality of inputs and a plurality of outputs, the static decoupling gain set comprising a plurality of gain value sets, wherein each gain value set decouples the plurality of inputs from the plurality of outputs at a frequency of interest and specified system operating condition of the gas flow handling system;
calculating at least one error term based on at least one of the inputs and at least one current value corresponding to at least one of the outputs;
providing at least one adjusted controller gain in response to a current system operating condition and the static decoupling gain set; and
determining a plurality of actuator responses based on the adjusted controller gain and the at least one error term.

13. The method of claim 12, wherein the plurality of inputs comprise an intake flow value command and an intake flow composition command.

14. The method of claim 13, wherein the intake flow value command comprises a charge mass flow command, and wherein the intake flow composition command comprises a member selected from the group consisting of an exhaust gas flow recirculation (EGR) fraction command, a fresh air flow command, and a charge O₂ fraction command.

15. The method of claim 14, wherein the plurality of outputs comprise a charge mass flow and a charge composition value.

16. The method of claim 15, wherein the charge composition value comprises a composition selected from the group consisting of an EGR fraction, a fresh air flow, and a charge O₂ fraction.

17. The method of claim 12, wherein the actuator responses comprise an exhaust gas recirculation (EGR) valve position command and a variable geometry turbine (VGT) position command.

18. The method of claim 17, wherein the plurality of outputs comprise a charge mass flow and a charge composition value.

19. The method of claim 18, wherein the charge composition value comprises a composition selected from the group consisting of an EGR fraction, a fresh air flow, and a charge O₂ fraction.

20. The method of claim 12, wherein the plurality of actuator responses comprises an exhaust gas recirculation (EGR) valve position and a turbocharger swallowing capacity modifier position.

21. A system, comprising:
an internal combustion engine having a charge flow and an exhaust flow;
a turbocharger adapted to receive at least a portion of the exhaust flow;
an exhaust gas recirculation (EGR) path adapted to supply a portion of the exhaust flow to the charge flow, the EGR path having an EGR valve adapted to control a flow area of the EGR path;
a turbocharger swallowing capacity modifier; and
a controller:
responsive to a current system operating condition, a charge flow command, a charge composition command, a current charge flow, and a current charge composition;
structured to determine at least one adjusted controller gain as a function of the current system operating condition and a static decoupling gain set;
structured to calculate a charge flow error term as a function of the charge flow command and the current charge flow;
structured to calculate a charge composition error term as a function of the charge composition command and the current charge composition; and
structured to determine an EGR valve position and a turbocharger swallowing capacity modifier position based on the at least one adjusted controller gain, the charge flow error term, and the charge composition error term.

22. The system of claim 21, wherein the charge composition command comprises an EGR fraction command.

23. The system of claim 21, wherein the static decoupling gain set comprises a set of decoupling matrices, each decoupling matrix corresponding to a system operating condition.

24. The system of claim 21, wherein the controller is further structured to:
provide an adjusted charge flow error term as a function of the charge flow error term and the at least one adjusted controller gain,
provide an adjusted charge composition error term as a function of the charge composition error term and the at least one adjusted controller gain, and
operate a control scheme on the adjusted charge flow error term and the adjusted charge composition error term.

25. The system of claim 24, wherein the control scheme comprises one of an H-infinity controller and a proportional-integral controller.

26. The system of claim 24, wherein the controller is further structured to filter the charge flow error term with a first lead-lag filter and to filter the charge composition error term with a second lead-lag filter, and wherein the controller is further structured to operate an integral control scheme on at least one of the unfiltered charge flow error term and the unfiltered charge composition error term to determine an EGR valve steady state correction response and a turbocharger swallowing capacity modifier steady state correction response.

27. The system of claim 21, wherein the turbocharger swallowing capacity modifier comprises a member selected from the group consisting of: a variable geometry turbocharger, a turbocharger wastegate valve, an intake valve, and an exhaust valve.
